(19) United States
(12) Patent Application Publication
(10) Pub. No.: US 2026/0138399 A1
(43) Pub. Date: May 21, 2026

(54) TIRE

(71) Applicant: TOYO TIRE CORPORATION, HYOGO (JP)

(72) Inventor: Masaru KOIKE, Hyogo (JP)

(21) Appl. No.: 19/389,591

(22) Filed: Nov. 14, 2025

(30) Foreign Application Priority Data
Nov. 18, 2024 (JP) 2024-201022

(51) Int. Cl. B60C 11/12; B60C 11/03

(52) U.S. Cl. CPC B60C 11/1204; B60C 11/0306; B60C 11/1263; B60C 2011/0353; B60C 2011/0358; B60C 2011/1213

(57) ABSTRACT

A tire 100 according to this invention includes a tread 1. The tread 1 includes a pair of shoulder lands 11 arranged on outer sides in a tire axial direction, a center land or center lands 12 arranged between the pair of shoulder lands 11, first circumferential grooves 13 each of which is arranged either between a respective one of the shoulder lands 11 and the center land 12 or between a respective one of the shoulder lands and one of the center lands that is positioned closer to the shoulder land and formed to extend in a zigzag shape in a tire circumferential direction, and a second circumferential groove 14 arranged in the center land 12 or between the center lands and formed to extend in a zigzag shape in the tire circumferential direction; and an amplitude A2 of the zigzag shape of the second circumferential groove 14 is equal to or smaller than an amplitude A1 of the zigzag shape of each of the first circumferential grooves 13.

### BACKGROUND OF THE INVENTION

### Field of the Invention

The present invention relates to a tire.

### Description of the Background Art

Tires are known in the art. For example, such a tire is disclosed in Japanese Patent Publication No. JP 7180771.

The above Japanese Patent Publication No. JP 7180771 discloses a tire including a tire body, and a tread formed on an outer circumference of the tire body. The tread of this tire includes a pair of shoulder lands arranged on the outside in a tire axial direction, center lands arranged between the pair of shoulder lands, shoulder main grooves each of which is arranged between a respective one of the shoulder lands and one of the center land that is positioned closer to the shoulder land and formed in a tire circumferential direction, and a center main groove arranged between the center lands. In addition, Japanese Patent Publication No. JP 7180771 states that the tire is used for a vehicle such as a light truck.

Here, light trucks that use such tires similar to those stated in the above Japanese Patent Publication No. JP 7180771 are often used for commercial purposes such as deliveries. In a vehicle such as a light truck used for commercial purposes, the overall weight of the vehicle varies greatly between a state in which the vehicle is fully loaded with cargo and a state in which the vehicle is empty of cargo. In this case, because the load acting on the tires also varies greatly, the ground contact shape of the tires also change significantly, leading to substantial changes in braking characteristics of the tires. For this reason, it is desirable to reduce such substantial changes in the braking characteristics of the tires even when the load acting on the tires fluctuates widely.

### SUMMARY OF THE INVENTION

The present invention is intended to solve the above problem, and one object of the present invention is to provide a tire capable of reducing fluctuations in braking characteristics of the tire even when the load acting on the tire fluctuates widely.

In order to attain the aforementioned object, a tire according to one aspect of the present invention includes a tread, wherein the tread includes a pair of shoulder lands arranged on outer sides in a tire axial direction, a center land or center lands arranged between the pair of shoulder lands, first circumferential grooves each of which is arranged either between a respective one of the shoulder lands and the center land or between a respective one of the shoulder lands and one of the center lands that is positioned closer to the shoulder land and formed to extend in a zigzag shape in a tire circumferential direction, and a second circumferential groove arranged in the center land or between the center lands and formed to extend in a zigzag shape in the tire circumferential direction; and an amplitude of the zigzag shape of the second circumferential groove is equal to or smaller than an amplitude of the zigzag shape of each of the first circumferential grooves. Here, the zigzag shape in the present invention refers to a shape that extends in the tire circumferential direction while oscillating from one side to the other in the tire axial direction. For example, such zigzag shapes include bent shapes each of which is formed by line segments joined at angles, meandering curves, and continuous wave shapes.

In the tire according to the one aspect of the present invention, as discussed above, first circumferential grooves each of which is arranged either between a respective one of the shoulder lands and the center land or between a respective one of the shoulder lands and one of the center lands that is positioned closer to the shoulder land and formed to extend in a zigzag shape in a tire circumferential direction, and a second circumferential groove arranged in the center land or between the center lands and formed to extend in a zigzag shape in the tire circumferential direction are provided. Accordingly, the first and second circumferential grooves formed in zigzag shapes can improve grip performance in the tire circumferential direction and the tire axial direction while reducing uneven wear on the center and shoulder lands by reducing imbalance in rigidity caused by the provided grooves. In addition, the amplitude of the zigzag shape of the second circumferential groove, which is arranged in the center land or between the center lands, is equal to or smaller than the amplitude of the zigzag shape of each of the first circumferential grooves, which are arranged either between the shoulder lands and the center land or between the shoulder lands and the center lands. Accordingly, since the amplitude of the zigzag shape of the second circumferential groove, which is arranged in the center land or between the center lands, is not greater than the amplitude of the zigzag shape of each of the first circumferential grooves, it is possible to reduce the deformation in the tire circumferential direction caused by the load on the center land or the center lands where the ground contact pressure is greater than on the shoulder lands as compared with a case where the amplitude of the zigzag shape of the second circumferential groove is greater than that of the first circumferential groove. In other words, in the case where the amplitude of the zigzag shape of the second circumferential groove, which is arranged in the center land or between the center lands, is greater than that of the first circumferential groove, because the oscillation of the boundary point between the second circumferential groove and the center land in the tire axial direction is large, the center land is likely to deform in the tire circumferential direction due to the load. Contrary to this, in a case where the amplitude of the zigzag shape of the second circumferential groove, which is arranged in the center land or between the center lands, is equal to or smaller than that of the first circumferential groove, because the oscillation of the boundary point between the second circumferential groove and the center land in the tire axial direction is not large, the center land is unlikely to deform in the tire circumferential direction due to the load. Consequently, since the deformation of the center land caused by the load acting on the tire can be reduced, it is possible to reduce substantial changes in the grip performance of the center land even when the load acting on the tire fluctuates widely. As a result, it is possible to reduce such substantial changes in the braking characteristics of the tire even when the load acting on the tire fluctuates widely. In addition, because the ground contact shape of the center land undergoes less deformation even when the load acting on the tire fluctuates widely, it is possible to reduce uneven wear on the center land.

In the tire according to the aforementioned one aspect, it is preferable that a groove width of the second circumferential groove is smaller than a groove width of each of the first circumferential grooves. According to this configuration, because the ground contact area of the center land or the center lands can be increased by the reduction in the groove width of the second circumferential groove, it is possible to surely provide sufficient grip performance of the center land or the center lands. In addition, the drainage performance of the first circumferential grooves can be increased by increasing the groove width of the first circumferential grooves. For these reasons, the braking performance of the tire can be improved under wet conditions.

In the tire according to the aforementioned one aspect, it is preferable that the amplitude of the zigzag shape of the second circumferential groove is not greater than 3% of a width of the tread. According to this configuration, because the amplitude of the zigzag shape of the second circumferential groove, which is arranged in the center land or between the center lands, can be surely reduced, it is possible to reliably reduce the deformation in the tire circumferential direction caused by the load on the center land or the center lands.

In the tire according to the aforementioned one aspect, it is preferable that the center land or each of the center lands includes center slits formed to be inclined with respect to the tire axial direction and connecting one of the first circumferential grooves to the second circumferential groove to divide the center land, and closed slits formed to extend from one of the first circumferential grooves and from the second circumferential groove and to be inclined with respect to the tire axial direction and terminating in the center land, or bent slits formed by line segments extending from one of the first circumferential grooves and the second circumferential groove to be inclined with respect to the tire axial direction and joined together to form a bent shape in the center land; and that an inclination angle of each of the center slits is equal to an inclination angle of each of the closed slits or each of the bent slits. This configuration can suppress the part of the center land that is demarcated by the center slit from being significantly deformed by the load, as compared to the case where the inclination angle of the center slit and the inclination angle of the closed slit or bent slit are different from each other. As a result, uneven wear on the center land or the center lands can be effectively reduced. In addition, because the closed slits (retracted or notched grooves) terminate in the center land, the closed slits can improve the grip performance. In addition, because the center land or each center land is not completely separated by the closed slits, reduction in rigidity of the center land can be prevented. In addition, because the bent slits, which form a bent shape in the center land or each center land, are provided, the grip performance can be improved both in the tire circumferential direction and in the tire axial direction.

In the tire in which the aforementioned center land or each of the aforementioned center lands includes the center slits, it is preferable that each of the shoulder lands includes shoulder slits extending from a respective one of the first circumferential grooves outward in the tire axial direction to be inclined and to divide the shoulder lands; and that inclination angles of the shoulder slits with respect to the tire axial direction are equal to each other. According to this configuration, because parts of each shoulder land separated by the shoulder slits can be prevented from being significantly deformed (displaced excessively) under load, it is possible to effectively reduce uneven wear on the shoulder land.

In the tire in which the aforementioned center land or each of the aforementioned center lands includes the center slits, it is preferable that the center land further includes center sipes formed to extend at an inclination angle identical to each of the center slits. According to this configuration, because the inclination angle of the center sipes is equal to that of the center slits, it is possible to prevent the center land from being significantly deformed (displaced excessively) under load. As a result, the grip performance of the center land can be improved by the center sipes, while uneven wear on the center land is reduced.

In the tire in which each of the aforementioned shoulder lands includes the shoulder slits, it is preferable that each of the shoulder lands further includes shoulder sipes connected to the first circumferential groove and formed to extend at an inclination angle identical to each of the shoulder slits. According to this configuration, because the inclination angle of the shoulder sipes is equal to that of the shoulder slits, it is possible to prevent the shoulder land from being significantly deformed (displaced excessively) under load. As a result, the grip performance of the shoulder land can be improved by the shoulder sipes, while uneven wear on the shoulder land is reduced.

In the tire in which each of the aforementioned shoulder lands includes the shoulder slits, it is preferable that an inclination direction of each of the center slits with respect to the tire axial direction is equal to an inclination direction of each of the shoulder slits; and that the center slits and the shoulder slits are formed such that a center line of each of the center slits intersects a center line of a corresponding one of the shoulder slits at a point within the shoulder slit. According to this configuration, because water discharged from the center slits can be guided to the shoulder slits for drainage, it is possible to effectively improve drainage performance under wet conditions.

In this configuration, it is preferable that the inclination angle of each of the center slits with respect to the tire axial direction is greater than the inclination angle of each of the shoulder slits with respect to the tire axial direction. According to this configuration, because the inclination angle of each of the center slits is large, it is possible to improve the grip performance in the tire axial direction of the center land or the center lands, which have a larger ground contact area than the shoulder lands and significantly influence grip performance.

In the tire in which each of the aforementioned shoulder lands includes the shoulder slits, it is preferable that an inclination direction of each of the center slits with respect to the tire axial direction is equal to an inclination direction of each of the shoulder slits; and that the center slits and the shoulder slits are formed such that a center line of each of the center slits is colinear with a center line of a corresponding one of the shoulder slits. According to this configuration, because water discharged from the center slits can be led to the shoulder slits for drainage, it is possible to effectively improve the drainage performance under wet conditions.

In the tire in which the aforementioned center land or each of the aforementioned center lands includes the center slits, it is preferable that the center land further includes raised bottom portions arranged in the bent slits and having a depth from not smaller than 35% to not greater than 55% of a depth of the second circumferential groove. According to this configuration, because the rigidity of the center land can be increased by the raised bottom portions, which have a depth smaller than the bent slits and have a depth from not smaller than 35% to not greater than 55% of the depth of the second circumferential groove, it is possible to effectively prevent deformation of the center land under load.

In the tire in which each of the aforementioned center lands includes the center slits, it is preferable that the center land or each of the center lands includes lands separated by the center slits, and raised bottom portions arranged in the center slits to connect the lands to each other and having a depth from not smaller than 35% to not greater than 55% of a depth of the second circumferential groove. According to this configuration, because the rigidity of the center land can be increased by the raised bottom portions, which have a depth smaller than the center slits and have a depth from not smaller than 35% to not greater than 55% of the depth of the second circumferential groove, it is possible to effectively prevent deformation of the center land under load.

In the tire in which the aforementioned center land or each of the aforementioned center lands includes the center slits, it is preferable that the inclination angle of each of center slits is not smaller than 15 to not greater than 25 degrees with respect to the tire axial direction. According to this configuration, the grip performance of the center land in the tire axial direction can be improved by setting the inclination angle of the center slits to be not smaller than 15 degrees. In addition, because reduction in the rigidity of the center land in the tire axial direction can be prevented by setting the inclination angle of the center slits to be not greater than 25 degrees, it is possible to more effectively prevent deformation of the center land under load.

In the tire in which the aforementioned center land or each of the aforementioned center lands includes the center slits, it is preferable that each of the bent slits includes a first portion connected to a corresponding one of the first circumferential groove as one of the line segments, a second portion connected to the second circumferential groove as another of the line segments, and a third portion connecting the first portion to the second portion; that an inclination angle of the first portion with respect to the tire axial direction is equal to an inclination angle of the second portion; and that a groove width of the third portion is smaller than a groove width of each of the first and second portions. According to this configuration, because the groove width of the third portion connecting the first portion to the second portion, which are inclined, it is possible to effectively prevent deformation of the center land under load.

In the tire according to the aforementioned one aspect, it is preferable that the tread includes three grooves as the first circumferential grooves and the second circumferential groove formed to extend in the tire circumferential direction, and four lands separated as the shoulder lands and the center lands by the three grooves. According to this configuration, it is possible to reduce substantial changes in the braking characteristics of the tire even when the load acting on the tire fluctuates widely in the tire that includes the tread having three grooves formed to extend in the tire circumferential direction and four lands separated by the three grooves.

In the tire according to the aforementioned one aspect, it is preferable that at least one of the first circumferential grooves or the second circumferential groove is formed to extend in a serrated zigzag shape in the tire circumferential direction, and has an internal angle between line segments of the groove that is not greater than 90 degrees. According to this configuration, the grip performance in the tire axial direction can be effectively improved by the first circumferential grooves or the second circumferential groove formed to extend in the serrated zigzag shape and having the internal angle not greater than 90 degrees.

According to the present invention, it is possible to reduce substantial changes in the braking characteristics of the tire even when the load acting on the tire fluctuates widely.

### BRIEF DESCRIPTION OF THE DRAWINGS

FIG. 1 is a perspective view showing a tire according to a first embodiment of the present invention.

FIG. 2 is a schematic cross-sectional view of the tire taken along a line II-II in FIG. 1.

FIG. 3 is a view showing a tread of the tire according to the first embodiment of the present invention.

FIG. 4 is an enlarged view of the tire tread according to the first embodiment of the present invention.

FIG. 5 is a cross-sectional view of the tread taken along a line V-V in FIG. 4.

FIG. 6 is a perspective view showing a tire according to a second embodiment of the present invention.

FIG. 7 is a view showing a tread of the tire according to the second embodiment of the present invention.

FIG. 8 is an enlarged view showing a tread of the tire according to the second embodiment of the present invention.

FIG. 9 is a cross-sectional view of the tread taken along a line IX-IX in FIG. 8.

FIG. 10 is a view showing a tread of a tire according to a third embodiment of the present invention.

FIG. 11 is a view showing a first circumferential groove of the tire according to the third embodiment of the present invention.

FIG. 12 is a view showing a second circumferential groove of the tire according to the third embodiment of the present invention.

FIG. 13 is an enlarged view showing the tread of the tire according to the third embodiment of the present invention.

FIG. 14 is a cross-sectional view of the tread taken along a line XIV-XIV in FIG. 13.

FIG. 15 is a view showing a tread of a tire according to a modified example of each of the first to third embodiments of the present invention.

### DESCRIPTION OF THE PREFERRED EMBODIMENT

The following description will describe embodiments embodying the present invention with reference to the drawings.

### (First Embodiment)

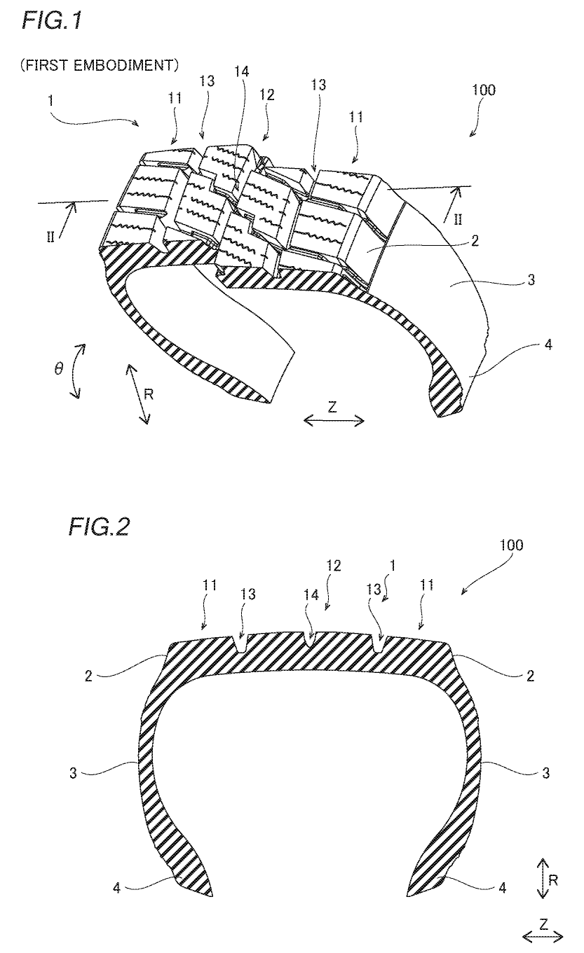

The following description describes a configuration of a tire 100 according to a first embodiment of the present invention with reference to FIGS. 1 to 5.

As shown in FIGS. 1 and 2, the tire 100 is configured to be mounted on a wheel and to support a load using air pressure, with its interior being filled with air. In other words, the tire 100 is an inflated tire. In addition, the tire 100 is installed on a moving body via the wheel to rotate about an axis of rotation. For example, the moving body is a vehicle such as a passenger car, truck, or bus. for example, the vehicle is moved when driven by a drive mechanism that includes at least one of an engine or an electric motor.

For example, the tire 100 is mounted on a light truck (vehicle) used for commercial purposes, such as deliveries. In the light truck used for deliveries, the overall weight of the vehicle varies greatly between a state in which the vehicle is fully loaded with cargo and a state in which the vehicle is empty of cargo. In other words, the load acting on the tire 100 fluctuates widely.

Here, for example, the tire 100 is an all-season tire used throughout the year, including both snow-free summer months and snowy winter months.

The tire 100 includes a tread 1, shoulders 2, sidewalls 3, and beads 4. The tread 1 is a part that comes into contact with the ground and has an uneven tread pattern having protruding/recessed shapes on its outer surface. The shoulders 2 are connected to the tread 1 and form outermost side surfaces of the tire 100. The sidewalls 3 are connected to the shoulders 2 and form side surfaces of the tire 100. The bead 4 is configured to be in contact with the wheel and to secure the tire 100 to the wheel.

### (Composition of Tread)

The tread 1 includes shoulder lands 11, center lands 12, first circumferential grooves 13, and a second circumferential groove 14, as shown in FIGS. 1 to 3. That is, the tread 1 includes three grooves (two first circumferential grooves 13 and one second circumferential groove 14) formed in a tire circumferential direction (θ direction) and four lands separated by the three grooves (two shoulder lands 11 and two center lands 12, which are two lands divided by the second circumferential groove 14). In other words, in the tread 1, a pair of shoulder lands 11 are arranged on outer sides to extend in the tire circumferential direction (θ direction); the center lands 12 are arranged between the pair of shoulder lands 11 to extend in the tire circumferential direction; each of the first circumferential grooves 13 is arranged between a respective one of the shoulder lands 11 and one of the center lands 12 that is positioned closer to the shoulder land to extend in the tire circumferential direction; and the second circumferential groove 14 is arranged between the center lands 12 to extend in the tire circumferential direction.

The pair of shoulder lands 11 are arranged on the outer sides of the tread 1 in the tire axial direction (Z direction). In other words, the shoulder lands 11 are arranged on the shoulder 2 sides (both outer sides in the Z direction) of the tread 1.

The shoulder lands 11 include shoulder slits 111 extending from the first circumferential grooves 13 outward in the tire axial direction to be inclined and to divide the shoulder lands 11. In addition, the shoulder lands 11 include shoulder sipes 112 connected to the first circumferential grooves 13.

The shoulder lands 11 include shoulder blocks 11a divided by the first circumferential grooves 13 and the shoulder slits 111.

The center lands 12 are arranged between the pair of shoulder lands 11. In other words, the center lands 12 are arranged in a central part of the tread 1 in the tire axial direction (Z direction).

Also, each of the center lands 12 has center slits 121 formed to be inclined with respect to the tire axial direction and connecting a respective one of the first circumferential grooves 13 to the second circumferential groove 14 to divide the center land 12. In addition, each of the center lands 12 has bent slits 122 each of which is formed by line segments extending from a respective one of the first circumferential grooves 13 and the second circumferential groove 14 to be inclined with respect to the tire axial direction and joined together to form a bent shape in the center land 12.

Each of the center lands 12 includes center blocks 12a and 12b divided by a respective one of the first circumferential grooves 13, the second circumferential groove 14, the center slits 121, and the bent slits 122. In addition, each of the center lands 12 has center sipes 123.

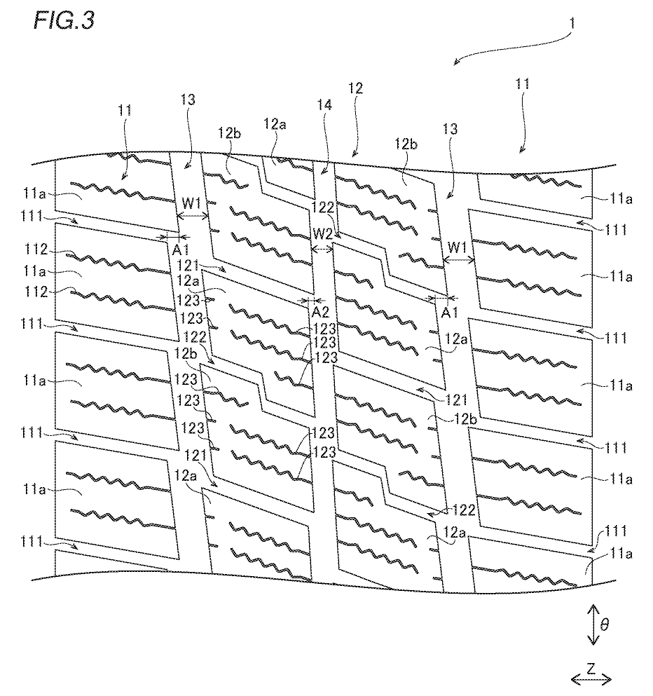

Here, in the first embodiment, each of the first circumferential grooves 13 is arranged between a respective one of the shoulder lands 11 and one of the center lands 12 that is positioned closer to the shoulder land and formed to extend in a zigzag shape in the tire circumferential direction (θ direction). Here, the zigzag shape refers to a shape that extends in the tire circumferential direction (Z direction) while oscillating from one side to the other in the tire axial direction. Such a zigzag shape include a bent shape formed by line segments joined at angles, a meandering curve, or a continuous wave shape. In the first embodiment, as shown in FIG. 3, each of the first circumferential grooves 13 is formed to extend in a zigzag shape with a bent shape created by connecting a series of inverted L-shapes.

Also, in the first embodiment, the second circumferential groove 14 is arranged between the center lands 12 and is formed to extend in a zigzag shape in the tire circumferential direction (θ direction). As shown in FIG. 3, the second circumferential groove 14 is formed to extend in a zigzag shape with a bent shape created by connecting a series of inverted L-shapes.

In addition, in the first embodiment, as shown in FIG. 3, an amplitude A2 of the zigzag shape of the second circumferential groove 14 is smaller than amplitudes A1 of the zigzag shapes of the first circumferential grooves 13 arranged between the shoulder lands 11 and the center lands 12. Here, the amplitudes A1 of the zigzag shapes of the pair of first circumferential grooves 13 are substantially equal to each other. Here, the amplitude of the zigzag shape of each groove is the distance between a point of a land that protrudes the most toward the groove and a point of the land that is recessed the most away from the land in the tire axial direction (Z direction).

The amplitude A1 of the zigzag shape of each first circumferential groove 13 is not greater than 10% of a width of the tread 1 (a length in the tire axial direction (Z direction)). Preferably, the amplitude A1 of the zigzag shape of each first circumferential groove 13 is not greater than 5% of the width of the tread 1 (the length in the tire axial direction (Z direction)). The amplitude A2 of the zigzag shape of the second circumferential groove 14 is not greater than 3% of a width of the tread 1 (a length in the tire axial direction (Z direction)).

Also, in the first embodiment, a groove width W2 of the second circumferential groove 14 is smaller than groove widths W1 of the first circumferential grooves 13, as shown in FIG. 3. The groove widths W1 of the pair of first circumferential grooves 13 are substantially equal to each other.

In the tread 1, a placement area of the shoulder lands 11 is substantially equal to a placement area of the center lands 12. For example, in the tread 1, the placement area of the shoulder lands 11 is slightly larger than the placement area of the center lands 12. For example, a ratio between the placement area of the shoulder lands 11 and the placement area of the center lands 12 is 52:48. Here, the boundaries between the shoulder lands 11 and the center lands 12 are defined by the centerlines of the first circumferential grooves 13.

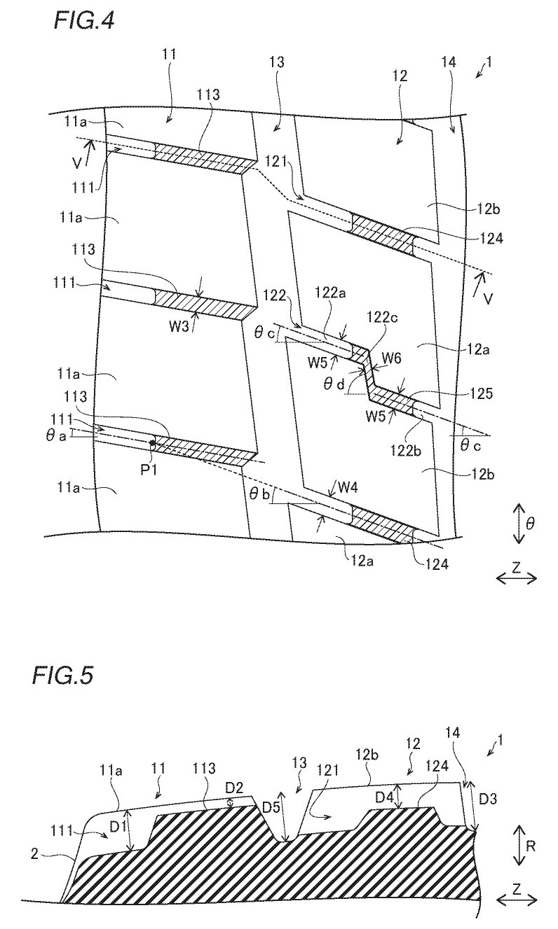

As shown in FIGS. 4 and 5, each center land 12 includes raised bottom portions 124 arranged in the center slits 121 to connect the center blocks 12a and 12b to each other. The raised bottom portion 124 has a depth from not smaller than 35% to not greater than 55% of a depth of the second circumferential groove 14 (main groove). Specifically, the second circumferential groove 14 has a depth D3, as shown in FIG. 5. The raised bottom portions 124 have a depth D4. The depth D4 of the raised bottom portions 124 is from not smaller than 35% to not greater than 55% of the depth D3 of the second circumferential groove 14.

As shown in FIG. 4, each center land 12 includes raised bottom portions 125 arranged in the bent slits 122 to connect the center blocks 12a and 12b to each other. The raised bottom portion 125 has a depth from not smaller than 35% to not greater than 55% of the depth of the second circumferential groove 14.

As shown in FIGS. 4 and 5, each shoulder land 11 includes raised bottom portions 113 arranged in the shoulder slits 111 to connect the shoulder blocks 11a adjacent to each other to each other. The raised bottom portion 113 has a depth from not smaller than 15% to not greater than 45% of the depth of the first circumferential groove 13 (main groove). As shown in FIG. 5, the depth of the raised bottom portion 113 is smaller than the depth of the raised bottom portion 124. The shoulder slits 111 of each shoulder land 11 has a depth D1. The raised bottom portions 113 has a depth D2. Also, the first circumferential grooves 13 have a depth D5.

In addition, as shown in FIG. 4, inclination angles of the shoulder slits 111 with respect to the tire axial direction (Z direction) are equal to each other. Specifically, the shoulder slits 111 are inclined at an angle θa with respect to the tire axial direction.

The inclination angle θa of the shoulder slits 111 is an acute angle (smaller than 90 degrees). For example, the shoulder slits 111 have an inclination angle from not smaller than 5 to not greater than 15 degrees with respect to the tire axial direction.

In addition, as shown in FIG. 4, an inclination angle of the center slits 121 is equal to an inclination angle of the bent slits 122. Specifically, the center slits 121 are inclined at an angle θb with respect to the tire axial direction (Z direction). In addition, each bent slit 122 includes a first portion 122a connected to a corresponding one of the first circumferential grooves 13 and a second portion 122b connected to the second circumferential groove 14, and the first and second portions are inclined at an angle θc with respect to the tire axial direction. Here, the angle θb = angle θc.

The inclination angle θb of the center slits 121 is an acute angle (smaller than 90 degrees). For example, the center slits 121 have an inclination angle from not smaller than 15 to not greater than 25 degrees with respect to the tire axial direction.

An inclination direction of the center slits 121 with respect to the tire axial direction (Z direction) is equal to an inclination direction of the shoulder slits 111. Specifically, as shown in FIG. 4, the center slits 121 and the shoulder slits 111 are formed to be inclined downward to the right relative to the tire axial direction.

In addition, the inclination angle θb of the center slits 121 with respect to the tire axial direction is greater than the inclination angle θa of the shoulder slits 111 with respect to the tire axial direction. In other words, the shoulder slits 111 are formed to extend in a direction more closely aligned with the tire axial direction than center slits 121. Conversely, the center slits 121 are formed to extend in a direction more inclined away from the tire axial direction than the shoulder slits 111.

In addition, as shown in FIG. 4, the center slits 121 and the shoulder slits 111 are formed such that the center line of each center slit 121 intersects the center line of a corresponding one of the shoulder slits 111 at a point within the shoulder slit 111. Specifically, the centerline of the center slit 121 and the centerline of the shoulder slit 111 intersect at a point P1 within the shoulder slit 111.

As shown in FIG. 4, the bent slit 122 includes the first portion 122a connected to the first circumferential groove 13, the second portion 122b connected to the second circumferential groove 14, and a third portion 122c connecting the first portion 122a to the second portion 122b. The first portion 122a and the second portion 122b are inclined at the angle θc with respect to the tire axial direction (Z direction). Also, the third portion 122c is inclined at an angle θd with respect to the tire axial direction.

The inclination angle of the first portion 122a and the second portion 122b of the bent slit 122 is an acute angle (smaller than 90 degrees). For example, the first portion 122a and the second portion 122b of the bent slit 122 have an inclination angle from not smaller than 15 to not greater than 25 degrees with respect to the tire axial direction. Also, the inclination angle of the third portion 122c of the bent slit 122 is an acute angle (smaller than 90 degrees). For example, the third portion 122c of the bent slit 122 has an inclination angle from not smaller than 70 to not greater than 85 degrees with respect to the tire axial direction.

As shown in FIG. 3, the shoulder sipes 112 are connected to the first circumferential groove 13 and formed to extend at the same inclination angle as the shoulder slits 111. In addition, the shoulder sipes 112 are formed in a zigzag shape extending along the direction defined by the inclination angle. The shoulder sipes 112 are also grooves formed in the shoulder land 11.

The center sipes 123 are formed to extend at the same inclination angle as the center slits 121. Here, some of the center sipes 123 are formed to be connected to the first circumferential grooves 13, and the other center sipes are formed to be connected to the second circumferential groove 14. The center sipes 123 are also formed in a zigzag shape extending along the direction defined by the inclination angle. The center sipes 123 are also grooves formed in the center lands 12.

### (Advantages of First Embodiment)

In the first embodiment, the following advantages are obtained.

In the first embodiment, as described above, the first circumferential grooves 13 each of which is arranged between a respective one of the shoulder lands 11 and one of the center lands 12 that is positioned closer to the shoulder land and formed to extend in a zigzag shape in a tire circumferential direction, and the second circumferential groove 14 arranged between the center lands 12 and formed to extend in a zigzag shape in the tire circumferential direction are provided. Accordingly, the first and second circumferential grooves 13 and 14 formed in zigzag shapes can improve grip performance in the tire circumferential direction and the tire axial direction while reducing uneven wear on the center lands 12 and the shoulder lands 11 by reducing imbalance in rigidity caused by the provided grooves. In addition, the amplitude A2 of the zigzag shape of the second circumferential groove 14, which is arranged between the center lands 12, is smaller than the amplitude A1 of the zigzag shape of each of the first circumferential grooves 13, which are are arranged between the shoulder lands 11 and the center lands 12. Accordingly, the smaller amplitude A2 of the zigzag shape of the second circumferential groove 14, which is arranged between the center lands 12, can reduce the deformation in the tire circumferential direction caused by the load on the center lands 12 where the ground contact pressure is greater than on the shoulder lands 11 as compared with a case where the amplitude A2 of the zigzag shape of the second circumferential groove 14 is larger. In other words, in the case where the amplitude A2 of the zigzag shape of the second circumferential groove 14, which is arranged between the center lands 12, is greater than that of the first circumferential groove, because the oscillation of the boundary point between the second circumferential groove 14 and the center land 12 in the tire axial direction is large, the center land 12 is likely to deform in the tire circumferential direction due to the load. Contrary to this, in a case where the amplitude A2 of the zigzag shape of the second circumferential groove 14, which is arranged between the center lands 12, is smaller than that of the first circumferential groove, because the oscillation of the boundary point between the second circumferential groove 14 and the center land 12 in the tire axial direction is smaller, the center land 12 is unlikely to deform in the tire circumferential direction due to the load. Consequently, since the deformation of the center land 12 caused by the load acting on the tire 100 can be reduced, it is possible to reduce substantial changes in the grip performance of the center land 12 even when the load acting on the tire 100 fluctuates widely. As a result, it is possible to reduce such substantial changes in the braking characteristics of the tire 100 even when the load acting on the tire 100 fluctuates widely. In addition, because the ground contact shape of the center land 12 undergoes less deformation even when the load acting on the tire 100 fluctuates widely, it is possible to reduce uneven wear on the center land 12.

Also, in the first embodiment, as described above, the groove width W2 of the second circumferential groove 14 is smaller than the groove widths W1 of the first circumferential grooves 13. According to this configuration, because the ground contact area of the center lands 12 can be increased by the reduction in the groove width W2 of the second circumferential groove 14, it is possible to surely provide sufficient grip performance of the center lands 12. In addition, the drainage performance of the first circumferential grooves 13 can be increased by increasing the groove width W1 of the first circumferential grooves 13. For these reasons, the braking performance of the tire can be improved under wet conditions.

Also, in the first embodiment, the amplitude A2 of the zigzag shape of the second circumferential groove 14 is not greater than 3% of a width of the tread 1. According to this configuration, because the amplitude A2 of the zigzag shape of the second circumferential groove 14, which is arranged between the center lands 12, can be surely reduced, it is possible to reliably reduce the deformation in the tire circumferential direction caused by the load on the center lands 12.

Also, in the first embodiment, as described above, each of the center lands 12 has the center slits 121 formed to be inclined with respect to the tire axial direction and connecting a respective one of the first circumferential grooves 13 to the second circumferential groove 14 to divide the center land 12, and the bent slits 122 each of which is formed by line segments extending from a respective one of the first circumferential grooves 13 and the second circumferential groove 14 to be inclined with respect to the tire axial direction and joined together to form a bent shape in the center land 12; and the inclination angle of the center slits 121 is equal to the inclination angle of the bent slits 122. Accordingly, it is possible to prevent substantial deformation of portions of the center land 12 divided by the center slits 121 under load as compared with a case where the inclination angle of the center slits 121 is different from the inclination angle of the bent slits 122. As a result, uneven wear on the center lands 12 can be effectively reduced. In addition, because the bent slits 122, which form a bent shape each of the center lands 12, are provided, the grip performance can be improved both in the tire circumferential direction and in the tire axial direction.

Also, in the first embodiment, as described above, each of the shoulder lands 11 includes the shoulder slits 111 extending from a respective one of the first circumferential grooves 13 outward in the tire axial direction to be inclined and to divide the shoulder lands 11, and inclination angles of the shoulder slits 111 with respect to the tire axial direction are equal to each other. Accordingly, because parts of each shoulder land 11 separated by the shoulder slits 111 can be prevented from being significantly deformed (displaced excessively) under load, it is possible to effectively reduce uneven wear on the shoulder land 11.

Also, in the first embodiment, as described above, the center land 12 includes the center sipes 123 formed to extend at the same inclination angle as each of the center slits 121. Accordingly, because the inclination angle of the center sipes 123 is equal to that of the center slits 121, it is possible to prevent the center land 12 from being significantly deformed (displaced excessively) under load. As a result, the grip performance of the center land 12 can be improved by the center sipes 123, while uneven wear on the center land 12 is reduced.

Also, in the first embodiment, as described above, each of the shoulder lands 11 includes the shoulder sipes 112 connected to the first circumferential groove 13 and formed to extend at the same inclination angle as each of the shoulder slits 111. Accordingly, because the inclination angle of the shoulder sipes 112 is equal to that of the shoulder slits 111, it is possible to prevent the shoulder land 11 from being significantly deformed (displaced excessively) under load. As a result, the grip performance of the shoulder land 11 can be improved by the shoulder sipes 112, while uneven wear on the shoulder land 11 is reduced.

Also, in the first embodiment, as described above, an inclination direction of the center slits 121 with respect to the tire axial direction is equal to an inclination direction of the shoulder slits 111, and the center slits 121 and the shoulder slits 111 are formed such that the center line of each center slit 121 intersects the center line of a corresponding one of the shoulder slits 111 at a point within the shoulder slit 111. Accordingly, because water discharged from the center slits 121 can be led to the shoulder slits 111 for drainage, it is possible to effectively improve the drainage performance under wet conditions.

Also, in the first embodiment, as described above, the inclination angle of the center slits 121 with respect to the tire axial direction is greater than the inclination angle of the shoulder slits 111 with respect to the tire axial direction. Accordingly, because the inclination angle of each of the center slits 121 is large, it is possible to improve the grip performance in the tire axial direction of the center lands 12, which have a larger ground contact area than the shoulder lands 11 and significantly influence grip performance.

Also, in the first embodiment, as described above, the bent slits 122 are arranged in the center lands 12, and have the raised bottom portions 125 having a depth from not smaller than 35% to not greater than 55% of the depth of the second circumferential groove (main groove) 14. Accordingly, because the rigidity of the center land 12 can be increased by the raised bottom portions 125, which have a depth smaller than the bent slits 122 and have a depth from not smaller than 35% to not greater than 55% of the depth of the second circumferential groove 14, it is possible to effectively prevent deformation of the center land 12 under load.

Also, in the first embodiment, as described above, each of the center lands 12 includes lands separated by the center slits 121, and raised bottom portions 124 arranged in the center slits 121 to connect the lands to each other and having a depth from not smaller than 35% to not greater than 55% of a depth of the second circumferential groove 14 (main groove). Accordingly, because the rigidity of the center land 12 can be increased by the raised bottom portions 124, which have a depth smaller than the center slits 121 and have a depth from not smaller than 35% to not greater than 55% of the depth of the second circumferential groove 14, it is possible to effectively prevent deformation of the center land 12 under load.

Also, in the first embodiment, as described above, the center slits 121 have an inclination angle from not smaller than 15 to not greater than 25 degrees with respect to the tire axial direction. Accordingly, the grip performance of the center land 12 in the tire axial direction can be improved by setting the inclination angle of the center slits 121 to be not smaller than 15 degrees. In addition, because reduction in the rigidity of the center land 12 in the tire axial direction can be prevented by setting the inclination angle of the center slits 121 to be not greater than 25 degrees, it is possible to more effectively prevent deformation of the center land 12 under load.

Also, in the first embodiment, as described above, the bent slit 122 includes the first portion 122a connected to the first circumferential groove 13, the second portion 122b connected to the second circumferential groove 14, and the third portion 122c connecting the first portion 122a to the second portion 122b. An inclination angle of the first portion 122a with respect to the tire axial direction is equal to an inclination angle of the second portion 122b; and a groove width of the third portion 122c is smaller than a groove width of each of the first and second portions 122a and 122b. Accordingly, because the groove width of the third portion 122c connecting the first portion 122a to the second portion 122b, which are inclined, it is possible to effectively prevent deformation of the center land 12 under load.

Also, in the first embodiment, as described above, the tread 1 includes three grooves formed to extend in the tire circumferential direction and four lands separated by the three grooves. Accordingly, it is possible to reduce substantial changes in the braking characteristics of the tire 100 even when the load acting on the tire 100 fluctuates widely in the tire 100 that includes the tread 1 having three grooves formed to extend in the tire circumferential direction and four lands separated by the three grooves.

### (Second Embodiment)

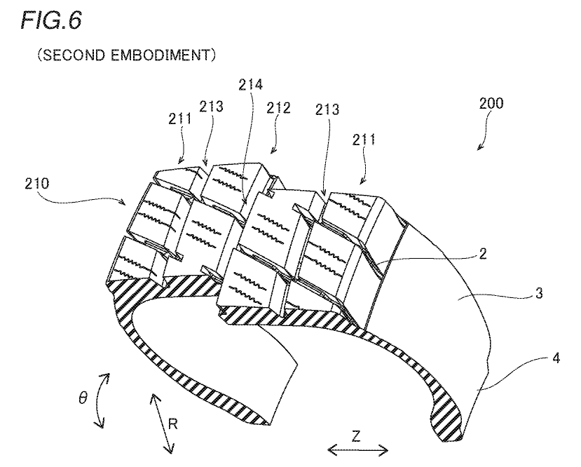

The following description describes a configuration of a tire 200 according to a second embodiment of the present invention with reference to FIGS. 6 to 9. A configuration in which closed slits 2122 of retracted or notched grooves are arranged in center lands 212 is described in the second embodiment dissimilar to the first embodiment in which the bent slits 122 are arranged in the center lands 12.

The tire 200 includes a tread 210, shoulders 2, sidewalls 3, and beads 4. The tread 210 is a part that comes into contact with the ground and has an uneven tread pattern having protruding/recessed shapes on its outer surface. The shoulders 2 are connected to the tread 210 and form outermost side surfaces of the tire 200. The sidewalls 3 are connected to the shoulders 2 and form side surfaces of the tire 200. The bead 4 is configured to be in contact with the wheel and to secure the tire 200 to the wheel.

### (Composition of Tread)

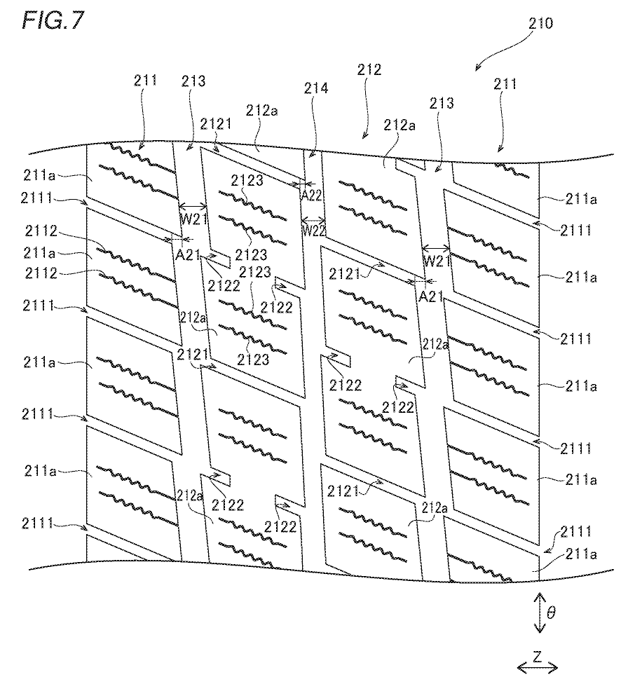

The tread 210 includes shoulder lands 211, center lands 212, first circumferential grooves 213, and a second circumferential groove 214, as shown in FIGS. 6 to 7. That is, the tread 210 includes three grooves (two first circumferential grooves 213 and one second circumferential groove 214) formed in a tire circumferential direction (θ direction) and four lands separated by the three grooves (two shoulder lands 211 and two center lands 212, which are two lands divided by the second circumferential groove 214).

The pair of shoulder lands 211 are arranged on the outer sides of the tread 210 in the tire axial direction (Z direction). In other words, shoulder lands 211 are arranged on the shoulder 2 sides (both outer sides in the Z direction) of the tread 210.

The shoulder lands 211 include shoulder slits 2111 extending from the first circumferential grooves 213 outward in the tire axial direction to be inclined and to divide the shoulder lands 211. In addition, the shoulder lands 211 include shoulder sipes 2112 connected to the first circumferential grooves 213.

The shoulder lands 211 include shoulder blocks 211a divided by the first circumferential grooves 213 and the shoulder slits 2111.

The center lands 212 are arranged between the pair of shoulder lands 211. In other words, the center lands 212 are arranged in a central part of the tread 210 in the tire axial direction (Z direction).

Also, each of the center lands 212 has center slits 2121 formed to be inclined with respect to the tire axial direction and connecting a respective one of the first circumferential grooves 213 to the second circumferential groove 214 to divide the center land 212. In addition, each of the center lands 212 has closed slits 2122 each of which is formed by line segments extending from a respective one of the first circumferential grooves 213 or the second circumferential groove 214 to be inclined with respect to the tire axial direction and terminating in the center land 212.

Each of the center lands 212 includes center blocks 212a divided by a respective one of the first circumferential grooves 213, the second circumferential groove 214, and the center slits 2121. In addition, each of the center lands 212 has center sipes 2123.

Here, in the second embodiment, each of the first circumferential grooves 213 is arranged between a respective one of the shoulder lands 211 and one of the center lands 212 that is positioned closer to the shoulder land and formed to extend in a zigzag shape in the tire circumferential direction (θ direction). In the second embodiment, as shown in FIG. 7, each of the first circumferential grooves 213 is formed to extend in a zigzag shape with a bent shape created by connecting a series of inverted L-shapes.

Also, in the second embodiment, the second circumferential groove 214 is arranged between the center lands 212 and is formed to extend in a zigzag shape in the tire circumferential direction (θ direction). As shown in FIG. 7, the second circumferential groove 214 is formed to extend in a zigzag shape with a bent shape created by connecting a series of inverted L-shapes.

In addition, in the second embodiment, as shown in FIG. 7, an amplitude A22 of the zigzag shape of the second circumferential groove 214 is smaller than amplitudes A21 of the zigzag shapes of the first circumferential grooves 213 arranged between the shoulder lands 211 and the center lands 212. Here, the amplitudes A21 of the zigzag shapes of the pair of first circumferential grooves 213 are substantially equal to each other.

The amplitude A21 of the zigzag shape of each first circumferential groove 213 is not greater than 10% of a width of the tread 210 (a length in the tire axial direction (Z direction)). Preferably, the amplitude A21 of the zigzag shape of each first circumferential groove 213 is not greater than 5% of the width of the tread 210 (the length in the tire axial direction (Z direction)). The amplitude A22 of the zigzag shape of the second circumferential groove 214 is not greater than 3% of a width of the tread 210 (a length in the tire axial direction (Z direction)).

Also, in the second embodiment, a groove width W22 of the second circumferential groove 214 is smaller than groove widths W21 of the first circumferential grooves 213, as shown in FIG. 7. The groove widths W21 of the pair of first circumferential grooves 213 are substantially equal to each other.

In the tread 210, a placement area of the shoulder lands 211 is substantially equal to a placement area of the center lands 212. For example, in the tread 210, the placement area of the shoulder lands 211 is slightly smaller than the placement area of the center lands 212. For example, a ratio between the placement area of the shoulder lands 211 and the placement area of the center lands 212 is 46:54. Here, the boundaries between the shoulder lands 211 and the center lands 212 are defined by the centerlines of the first circumferential grooves 213.

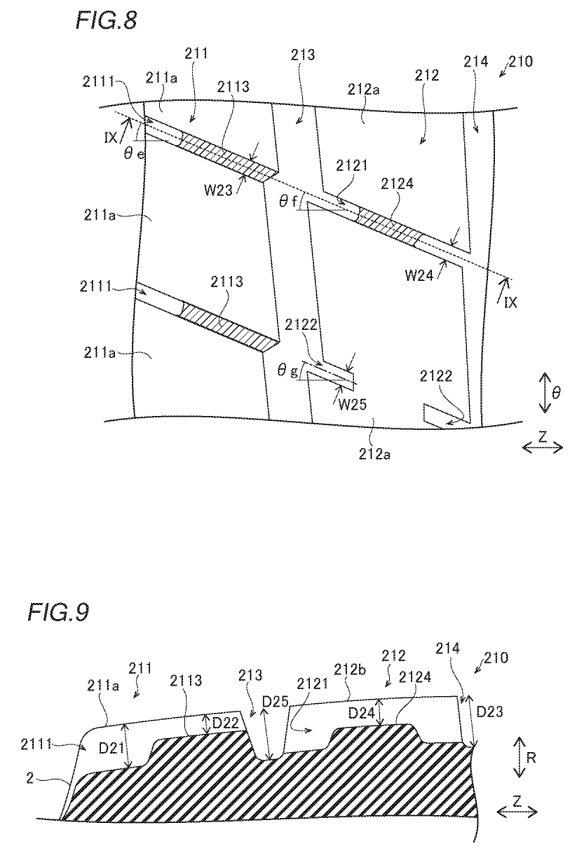

As shown in FIGS. 8 and 9, each center land 212 includes raised bottom portions 2124 arranged in the center slits 2121 to connect the center blocks 212a adjacent to each other to each other. The raised bottom portion 2124 has a depth from not smaller than 35% to not greater than 55% of a depth of the second circumferential groove 214 (main groove). Specifically, the second circumferential groove 214 between the center lands 212 has a depth D23, as shown in FIG. 9. The raised bottom portions 2124 has a depth D24. The depth D24 of the raised bottom portions 2124 is from not smaller than 35% to not greater than 55% of the depth D23 of the second circumferential groove 214.

As shown in FIGS. 8 and 9, each shoulder land 211 includes raised bottom portions 2113 arranged in the shoulder slits 2111 to connect the shoulder blocks 211a adjacent to each other to each other. The raised bottom portion 2113 has a depth from not smaller than 15% to not greater than 45% of the depth of the first circumferential groove 213 (main groove). As shown in FIG. 9, the depth of the raised bottom portion 2113 is smaller than the depth of the raised bottom portion 2124. The shoulder slits 2111 of each shoulder land 211 has a depth D21. The raised bottom portions 2113 has a depth D22. Also, the first circumferential grooves 213 have a depth D25.

In addition, as shown in FIG. 8, inclination angles of the shoulder slits 2111 with respect to the tire axial direction (Z direction) are equal to each other. Specifically, the shoulder slits 2111 are inclined at an angle θe with respect to the tire axial direction.

The inclination angle θe of the shoulder slits 2111 is an acute angle (smaller than 90 degrees). For example, the shoulder slits 2111 have an inclination angle from not smaller than 15 to not greater than 25 degrees with respect to the tire axial direction.

In addition, as shown in FIG. 8, an inclination angle of the center slits 2121 is equal to an inclination angle of the closed slits 2122. Specifically, the center slits 2121 are inclined at an angle θf with respect to the tire axial direction (Z direction). Also, the closed slits 2122 are inclined at an angle θg with respect to the tire axial direction. Here, the angle θf = angle θg.

The inclination angle θf of the center slits 2121 is an acute angle (smaller than 90 degrees). For example, the center slits 2121 have an inclination angle from not smaller than 15 to not greater than 25 degrees with respect to the tire axial direction.

An inclination direction of the center slits 2121 with respect to the tire axial direction (Z direction) is equal to an inclination direction of the shoulder slits 2111. Specifically, as shown in FIG. 8, the center slits 2121 and the shoulder slits 2111 are formed to be inclined downward to the right relative to the tire axial direction. Also, the inclination angle of the center slits 2121 with respect to the tire axial direction (Z direction) is equal to the inclination angle of the shoulder slits 2111. That is, angle θf = angle θe.

In addition, the center slits 2121 and the shoulder slits 2111 are formed such that a center line of each of the center slits 2121 is colinear with a center line of a corresponding one of the shoulder slits 2111.

As shown in FIG. 7, the shoulder sipes 2112 are connected to the first circumferential groove 213 and formed to extend at the same inclination angle as the shoulder slits 2111. In addition, the shoulder sipes 2112 are formed in a zigzag shape extending along the direction defined by the inclination angle. The shoulder sipes 2112 are also grooves formed in the shoulder land 211.

The center sipes 2123 are formed to extend at the same inclination angle as the center slits 2121. Here, some of the center sipes 2123 are formed to be connected to the first circumferential grooves 213, and the other center sipes are formed to be connected to the second circumferential groove 214. The center sipes 2123 are also formed in a zigzag shape extending along the direction defined by the inclination angle. The center sipes 2123 are also grooves formed in the center lands 212.

Other configurations of the second embodiment are the same as the aforementioned first embodiment.

### (Advantages of Second Embodiment)

In the second embodiment, the following advantages are obtained.

In the second embodiment, similar to the first embodiment, the first circumferential grooves 213 each of which is arranged between a respective one of the shoulder lands 211 and one of the center lands 212 that is positioned closer to the shoulder land and formed to extend in a zigzag shape in a tire circumferential direction, and the second circumferential groove 214 arranged between the center lands 212 and formed to extend in a zigzag shape in the tire circumferential direction are provided. Accordingly, the first and second circumferential grooves 213 and 214 formed in zigzag shapes can improve grip performance in the tire circumferential direction and the tire axial direction while reducing uneven wear on the center lands 212 and the shoulder lands 211 by reducing imbalance in rigidity caused by the provided grooves. In addition, the amplitude A22 of the zigzag shape of the second circumferential groove 214, which is arranged between the center lands 212, is smaller than the amplitude A21 of the zigzag shape of each of the first circumferential grooves 213, which are the shoulder lands 211 and the center lands 212. Consequently, it is possible to reduce such substantial changes in the braking characteristics of the tire 200 even when the load acting on the tire 200 fluctuates widely.

Also, in the second embodiment, as described above, each of the center lands 212 has the center slits 2121 formed to be inclined with respect to the tire axial direction and connecting a respective one of the first circumferential grooves 213 to the second circumferential groove 214 to divide the center land 212, and the closed slits 2122 each of which is formed by line segments extending from a respective one of the first circumferential grooves 213 or the second circumferential groove 214 to be inclined with respect to the tire axial direction and terminating in the center land 212. In addition, an inclination angle of the center slits 2121 is equal to an inclination angle of the closed slits 2122. Accordingly, it is possible to prevent substantial deformation of portions of the center land 212 divided by the center slits 2121 under load as compared with a case where the inclination angle of the center slits 2121 is different from the inclination angle of the closed slits 2122. As a result, uneven wear on the center lands 212 can be effectively reduced. In addition, because the closed slits 2122 terminate in the center land 212, the closed slits 2122 can improve the grip performance. In addition, because each of the center lands 212 is not completely separated by the closed slits 2122, reduction in rigidity of the center land 212 can be prevented.

Also, in the second embodiment, as described above, the inclination direction of the center slits 2121 with respect to the tire axial direction is equal to an inclination direction of the shoulder slits 2111. In addition, the center slits 2121 and the shoulder slits 2111 are formed such that a center line of each of the center slits 2121 is colinear with a center line of a corresponding one of the shoulder slits 2111. Accordingly, because water discharged from the center slits 2121 can be led to the shoulder slits 2111 for drainage, it is possible to effectively improve the drainage performance under wet conditions.

The other advantages of the second embodiment are similar to the first embodiment.

### (Third Embodiment)

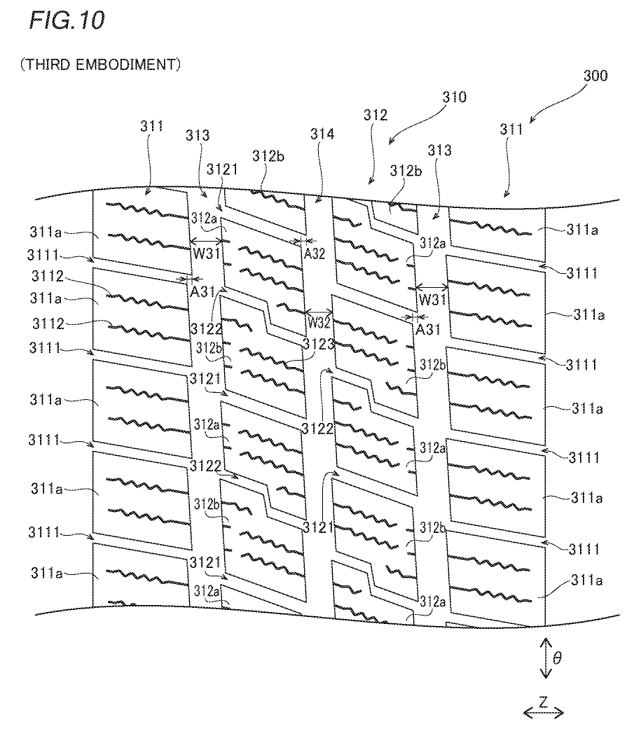

The following description describes a configuration of a tire 300 according to a third embodiment of the present invention with reference to FIGS. 10 to 14. A configuration in which an amplitude A32 of a zigzag shape of the second circumferential groove 314 is equal to an amplitude A31 of a zigzag shape of each of the first circumferential grooves 313 is described in the third embodiment dissimilar to the first and second embodiments in which the amplitude of the zigzag shape of the second circumferential groove is smaller than the amplitude of the zigzag shape of each of the first circumferential grooves.

The tire 300 includes a tread 310, shoulders 2, sidewalls 3, and beads 4. The tread 310 is a part that comes into contact with the ground and has an uneven tread pattern having protruding/recessed shapes on its outer surface. The shoulders 2 are connected to the tread 310 and form outermost side surfaces of the tire 300. The sidewalls 3 are connected to the shoulders 2 and form side surfaces of the tire 300. The bead 4 is configured to be in contact with the wheel and to secure the tire 300 to the wheel.

### (Composition of Tread)

The tread 310 includes shoulder lands 311, center lands 312, first circumferential grooves 313, and a second circumferential groove 314, as shown in FIG. 10. That is, the tread 310 includes three grooves (two first circumferential grooves 313 and one second circumferential groove 314) formed in a tire circumferential direction (θ direction) and four lands separated by the three grooves (two shoulder lands 311 and center lands 312, which are two lands divided by the second circumferential groove 314).

The pair of shoulder lands 311 are arranged on the outer sides of the tread 310 in the tire axial direction (Z direction). In other words, the shoulder lands 311 are arranged on the shoulder 2 sides (both outer sides in the Z direction) of the tread 310.

The shoulder lands 311 include shoulder slits 3111 extending from the first circumferential grooves 313 outward in the tire axial direction to be inclined and to divide the shoulder lands 311. In addition, the shoulder lands 311 include shoulder sipes 3112 connected to the first circumferential grooves 313.

The shoulder lands 311 include shoulder blocks 311a divided by the first circumferential grooves 313 and the shoulder slits 3111.

The center lands 312 are arranged between the pair of shoulder lands 311. In other words, the center lands 312 are arranged in a central part of the tread 310 in the tire axial direction (Z direction).

Also, each of the center lands 312 has center slits 3121 formed to be inclined with respect to the tire axial direction and connecting a respective one of the first circumferential grooves 313 to the second circumferential groove 314 to divide the center land 312. In addition, each of the center lands 312 has bent slits 3122 each of which is formed by line segments extending from a respective one of the first circumferential grooves 313 and the second circumferential groove 314 to be inclined with respect to the tire axial direction and joined together to form a bent shape in the center land 312.

Each of the center lands 312 includes center blocks 312a and 312b divided by a respective one of the first circumferential grooves 313, the second circumferential groove 314, the center slits 3121, and the bent slits 3122. In addition, each of the center lands 312 has center sipes 3123.

Here, in the third embodiment, each of the first circumferential grooves 313 is arranged between a respective one of the shoulder lands 311 and one of the center lands 312 that is positioned closer to the shoulder land and formed to extend in a zigzag shape in the tire circumferential direction (θ direction). In the third embodiment, as shown in FIG. 10, each of the first circumferential grooves 313 is formed to extend in a zigzag shape with a bent shape created by connecting a series of inverted L-shapes.

Also, in the third embodiment, the second circumferential groove 314 is arranged between the center lands 312 and is formed to extend in a zigzag shape in the tire circumferential direction (θ direction). As shown in FIG. 10, the second circumferential groove 314 is formed to extend in a zigzag shape with a bent shape created by connecting a series of inverted L-shapes.

In addition, in the third embodiment, as shown in FIGS. 10 to 12, an amplitude A32 of the zigzag shape of the second circumferential groove 314 is substantially equal to (the same as) amplitudes A31 of the zigzag shapes of the first circumferential grooves 313 arranged between the shoulder lands 311 and the center lands 312. Also, the amplitudes A31 of the zigzag shapes of the pair of first circumferential grooves 313 are substantially equal to each other.

The amplitude A31 of the zigzag shape of each first circumferential groove 313 is not greater than 5% of a width of the tread 310 (a length in the tire axial direction (Z direction)). Preferably, the amplitude A31 of the zigzag shape of each first circumferential groove 313 is not greater than 3% of the width of the tread 310 (the length in the tire axial direction (Z direction)). The amplitude A32 of the zigzag shape of the second circumferential groove 314 is not greater than 5% of a width of the tread 310 (a length in the tire axial direction (Z direction)). Preferably, the amplitude A32 of the zigzag shape of each second circumferential groove 314 is not greater than 3% of the width of the tread 310 (the length in the tire axial direction (Z direction)).

Also, in the third embodiment, a groove width W32 of the second circumferential groove 314 is smaller than groove widths W31 of the first circumferential grooves 313, as shown in FIG. 10. The groove widths W31 of the pair of first circumferential grooves 313 are substantially equal to each other.

In the tread 310, a placement area of the shoulder lands 311 is substantially equal to a placement area of the center lands 312. For example, in the tread 310, the placement area of the shoulder lands 311 is slightly larger than the placement area of the center lands 312. For example, a ratio between the placement area of the shoulder lands 311 and the placement area of the center lands 312 is 54:46. Here, the boundaries between the shoulder lands 311 and the center lands 312 are defined by the centerlines of the first circumferential grooves 313.

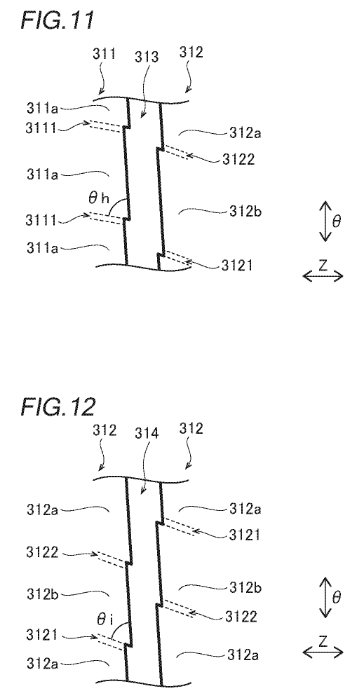

Here, in the third embodiment, as shown in FIG. 11, the first circumferential grooves 313 are formed to extend in a serrated zigzag shape in the tire circumferential direction (θ direction), have an internal angle θh between their line segments that is not greater than 90 degrees. Also, as shown in FIG. 12, the second circumferential groove 314 is formed to extend in a serrated zigzag shape in the tire circumferential direction (θ direction), and has an internal angle θi between its line segments that is not greater than 90 degrees.

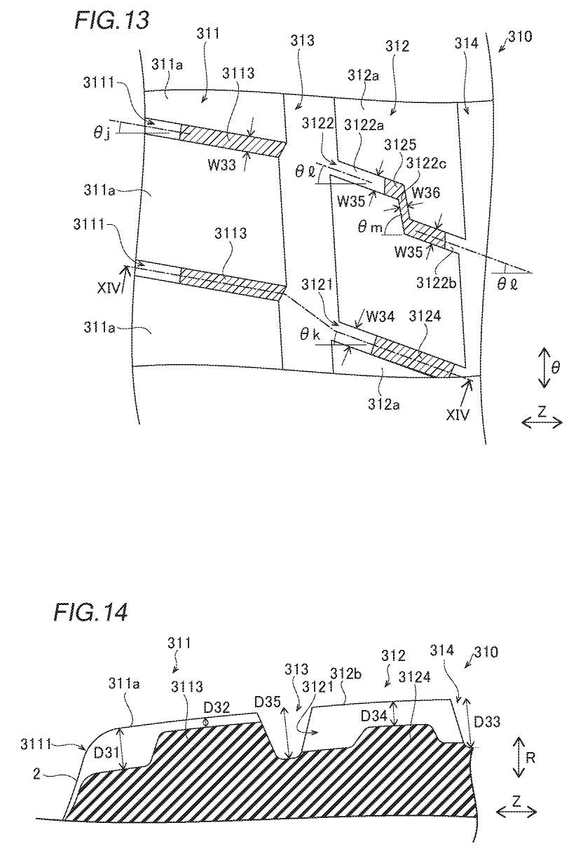

As shown in FIGS. 13 and 14, each center land 312 includes raised bottom portions 3124 arranged in the center slits 3121 to connect the center blocks 312a and 312b to each other. The raised bottom portion 3124 has a depth from not smaller than 35% to not greater than 55% of a depth of the second circumferential groove 314 (main groove). Specifically, the second circumferential groove 314 has a depth D33, as shown in FIG. 14. The raised bottom portions 3124 has a depth D34. The depth D34 of the raised bottom portions 3124 is from not smaller than 35% to not greater than 55% of the depth D33 of the second circumferential groove 314.

As shown in FIG. 13, each center land 312 includes raised bottom portions 3125 arranged in the bent slits 3122 to connect the center blocks 312a and 312b to each other. The raised bottom portion 3125 has a depth from not smaller than 35% to not greater than 55% of the depth of the second circumferential groove 314.

As shown in FIGS. 13 and 14, each shoulder land 311 includes raised bottom portions 3113 arranged in the shoulder slits 3111 to connect the shoulder blocks 311a adjacent to each other to each other. The raised bottom portion 3113 has a depth from not smaller than 15% to not greater than 45% of the depth of the first circumferential groove 313 (main groove). As shown in FIG. 14, the depth of the raised bottom portion 3113 is smaller than the depth of the raised bottom portion 3124. The shoulder slits 3111 of each shoulder land 311 has a depth D31. The raised bottom portions 3113 has a depth D32. Also, the first circumferential grooves 313 have a depth D35.

In addition, as shown in FIG. 13, inclination angles of the shoulder slits 3111 with respect to the tire axial direction (Z direction) are equal to each other. Specifically, the shoulder slits 3111 are inclined at an angle θj with respect to the tire axial direction.

The inclination angle θj of the shoulder slits 3111 is an acute angle (smaller than 90 degrees). For example, the shoulder slits 3111 have an inclination angle from not smaller than 5 to not greater than 15 degrees with respect to the tire axial direction.

In addition, as shown in FIG. 13, an inclination angle of the center slits 3121 is equal to an inclination angle of the bent slits 3122. Specifically, the center slits 3121 are inclined at an angle θk with respect to the tire axial direction (Z direction). In addition, each bent slit 3122 includes a first portion 3122a connected to a corresponding one of the first circumferential grooves 313 and a second portion 3122b connected to the second circumferential groove 314, and the first and second portions are inclined at an angle θl with respect to the tire axial direction. Here, the angle θk = angle θl.

The inclination angle θk of the center slits 3121 is an acute angle (smaller than 90 degrees). For example, the center slits 3121 have an inclination angle from not smaller than 15 to not greater than 25 degrees with respect to the tire axial direction.

An inclination direction of the center slits 3121 with respect to the tire axial direction (Z direction) is equal to an inclination direction of the shoulder slits 3111. Specifically, as shown in FIG. 13, the center slits 3121 and the shoulder slits 3111 are formed to be inclined downward to the right relative to the tire axial direction.

In addition, the inclination angle θk of the center slits 3121 with respect to the tire axial direction is greater than the inclination angle θj of the shoulder slits 3111 with respect to the tire axial direction. In other words, the shoulder slits 3111 are formed to extend in a direction more closely aligned with the tire axial direction than center slits 3121. Conversely, the center slits 3121 are formed to extend in a direction more inclined away from the tire axial direction than the shoulder slits 3111.

As shown in FIG. 13, the bent slit 3122 includes the first portion 3122a connected to the first circumferential groove 313, the second portion 3122b connected to the second circumferential groove 314, and a third portion 3122c connecting the first portion 3122a to the second portion 3122b. The first portion 3122a and the second portion 3122b are inclined at the angle θl with respect to the tire axial direction (Z direction). Also, the third portion 3122c is inclined at an angle θm with respect to the tire axial direction.

The inclination angle of the first portion 3122a and the second portion 3122b of the bent slit 3122 is an acute angle (smaller than 90 degrees). For example, the first portion 3122a and the second portion 3122b of the bent slit 3122 have an inclination angle from not smaller than 15 to not greater than 25 degrees with respect to the tire axial direction. Also, the inclination angle of the third portion 3122c of the bent slit 3122 is an acute angle (smaller than 90 degrees). For example, the third portion 3122c of the bent slit 3122 has an inclination angle from not smaller than 70 to not greater than 85 degrees with respect to the tire axial direction.

As shown in FIG. 10, the shoulder sipes 3112 are connected to the first circumferential groove 313 and formed to extend at the same inclination angle as the shoulder slits 3111. In addition, the shoulder sipes 3112 are formed in a zigzag shape extending along the direction defined by the inclination angle. The shoulder sipes 3112 are also grooves formed in the shoulder land 311.

The center sipes 3123 are formed to extend at the same inclination angle as the center slits 3121. Here, some of the center sipes 3123 are formed to be connected to the first circumferential grooves 313, and the other center sipes are formed to be connected to the second circumferential groove 314. The center sipes 3123 are also formed in a zigzag shape extending along the direction defined by the inclination angle. The center sipes 3123 are also grooves formed in the center lands 312.

Other configurations of the third embodiment are the same as the first embodiment above.

### (Advantages of Third Embodiment)

In the third embodiment, the following advantages are obtained.

In the third embodiment, similar to the first embodiment, the first circumferential grooves 313 each of which is arranged between a respective one of the shoulder lands 311 and one of the center lands 312 that is positioned closer to the shoulder land and formed to extend in a zigzag shape in a tire circumferential direction, and the second circumferential groove 314 arranged between the center lands 312 and formed to extend in a zigzag shape in the tire circumferential direction are provided. Accordingly, the first and second circumferential grooves 313 and 314 formed in zigzag shapes can improve grip performance in the tire circumferential direction and the tire axial direction while reducing uneven wear on the center lands 312 and the shoulder lands 311 by reducing imbalance in rigidity caused by the provided grooves.

In addition, in the third embodiment, the amplitude A32 of the zigzag shape of the second circumferential groove 314, which is arranged between the center lands 312, is equal to the amplitude A31 of the zigzag shape of each of the first circumferential grooves 313, which are arranged between the shoulder lands 311 and the center lands 312. Consequently, it is possible to reduce such substantial changes in the braking characteristics of the tire 300 even when the load acting on the tire 300 fluctuates widely.

Also, in the third embodiment, the first circumferential grooves 313 and the second circumferential groove 314 are formed to extend in serrated zigzag shapes in the tire circumferential direction, and have internal angles between their line segments that are not greater than 90 degrees. Accordingly, the grip performance in the tire axial direction can be effectively improved by the first circumferential grooves 313 and the second circumferential groove 314 formed to extend in the serrated zigzag shapes in the tire circumferential direction and having the internal angles not greater than 90 degrees.

In addition, according to the aforementioned configuration in the third embodiment, because water on the road surface under wet conditions can be effectively channeled into the first circumferential grooves 313 and the second circumferential groove 314, and the remaining water film can be adsorbed by the shoulder sipes 3112 and the center sipes 3123, it is possible to effectively improve the drainage performance under wet conditions.

The other advantages of the third embodiment are similar to the first embodiment.

### [Modified Embodiments]

Note that the embodiment disclosed this time must be considered as illustrative in all points and not restrictive. The scope of the present invention is not shown by the above description of the embodiments but by the scope of claims for patent, and all modifications (modified examples) within the meaning and scope equivalent to the scope of claims for patent are further included.

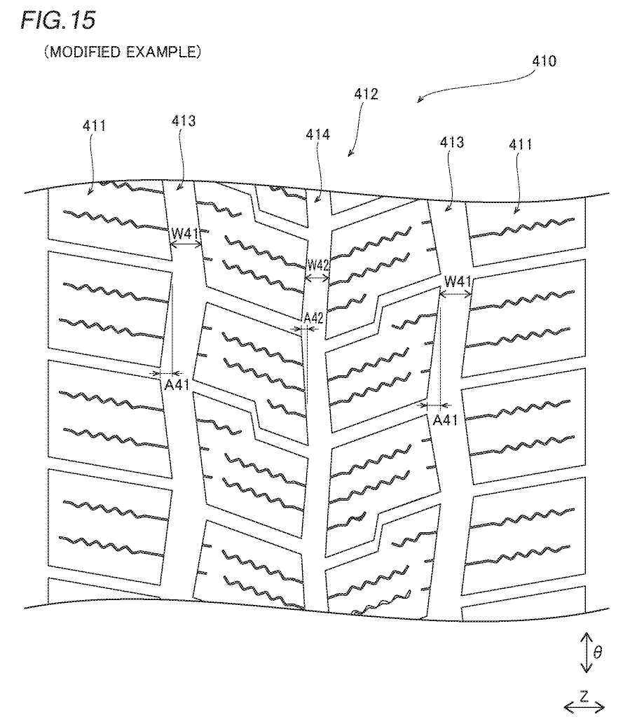

While the example in which the first circumferential grooves 13 (213, 313) and the second circumferential groove 14 (214, 314) are each formed to extend in a zigzag shape with a bent shape created by connecting a series of inverted L-shapes has been shown in the aforementioned first to third embodiments, the present invention is not limited to this. In the present invention, the first circumferential grooves may have a shape other than a bent shape defined by connecting a series of inverted L-shapes. Also, the second circumferential groove may have a shape other than a bent shape defined by connecting a series of inverted L-shapes. For example, as in a modified embodiment shown in FIG. 15, first circumferential groove 413 of a tread 410 may be formed in a zigzag shape with a bent shape created by connecting a series of W-shapes. Also, a second circumferential groove 414 may be formed in a zigzag shape with a bent shape created by connecting a series of W-shapes.

Here, the tread 410 according to the modified embodiment shown in FIG. 15 includes the shoulder lands 411, center lands 412, the first circumferential grooves 413, and the second circumferential groove 414. Also, each of the first circumferential grooves 413 is arranged between a respective one of the shoulder lands 411 and one of the center lands 412 that is positioned closer to the shoulder land and formed to extend in a zigzag shape in the tire circumferential direction (θ direction). The second circumferential groove 414 is arranged between the center lands 412 and is formed to extend in a zigzag shape in the tire circumferential direction (θ direction). In addition, an amplitude A42 of the zigzag shape of the second circumferential groove 414 is equal to or smaller than amplitudes A41 of the zigzag shapes of the first circumferential grooves 313 arranged between the shoulder lands 411 and the center lands 412. Here, the amplitudes A41 of the zigzag shapes of the pair of first circumferential grooves 413 are substantially equal to each other. In addition, the groove width W42 of the second circumferential groove 414 is smaller than the groove widths W41 of the first circumferential grooves 413. The groove widths W41 of the pair of first circumferential grooves 413 are substantially equal to each other. Also, in the case of the zigzag-shaped first and second circumferential grooves 413 and 414 according to the modified embodiment shown in FIG. 15, it is possible to reduce such substantial changes in the braking characteristics of the tire even when the load acting on the tire fluctuates widely similar to the zigzag-shaped first and second circumferential grooves 13 and 14 according to the first embodiment shown in FIG. 3, and the zigzag-shaped first and second circumferential grooves 213 and 214 according to the second embodiment shown in FIG. 7.

While the example in which the groove width of the second circumferential groove 14 (214, 314) is smaller than the groove width of the first circumferential groove 13 (213, 313) has been shown in the aforementioned first to third embodiments, the present invention is not limited to this. In the present invention, the groove width of the second circumferential groove and the groove width of the first circumferential grooves may be equal to each other, or the groove width of the second circumferential groove may be greater than groove width of the first circumferential grooves.

While the example in which the tire 100 (200, 300) is used on a light truck as a vehicle has been shown in the aforementioned first to third embodiments, the present invention is not limited to this. In the present invention, the tire may be used for a vehicle other than the light truck. The tire is particularly effective for use on a vehicle subjected to widely fluctuating loads.

While the example in which the tire 100 (200, 300) is an all-season tire has been shown in the aforementioned third embodiment, the present invention is not limited to this. In the present invention, the tire may be a type other than the all-season tire. For example, the tire may be a summer tire (normal tire) or winter tire (studless tire).

While the example in which the tire 100 (200, 300) is a pneumatic tire that supports a load using internal air pressure has been shown in the aforementioned first to third embodiments, the present invention is not limited to this. In the present invention, the tire may be a type other than a pneumatic tire. For example, a tire may be a that includes internal support members, such as spokes, and supports a load by means of these support members.

While the example in which the two center lands 12 (212, 312) are divided in the tire axial direction by one second circumferential groove 14 (214, 314) has been shown in the aforementioned first to third embodiments, the present invention is not limited to this. In the present invention, two or more second circumferential grooves may be provided so that three or more center lands may be divided in the tire axial direction from each other.

While the example in which the center slits 121 (2121) are arranged in each of the center lands 12 (212) so that the center land 12 (212) is divided into blocks in the tire circumferential direction has been shown in the aforementioned first and second embodiments. In the present invention, the center slits may not be arranged in the center land.

While the example in which the center slits 121 (2121, 3121) arranged in the each of the center lands 12 (212, 312) have the same inclination angle as each other with respect to the tire axial direction has been shown in the aforementioned first to third embodiments, the present invention is not limited to this. In the present invention, the center slits arranged in the center land may have different inclination angles from each other with respect to the tire axial direction.

While the example in which the raised bottom portions 124 (2124, 3124) are arranged in the center slits 121 (2121, 3121) of each of the center lands 12 (212, 312) has been shown in the aforementioned first to third embodiments, the present invention is not limited to this. In the present invention, the raised bottom portions may not be arranged in the center slits.

While the example in which the bent slits 122 (3122) are arranged in the each of the center lands 12 (312) has been shown in the aforementioned first and third embodiments, and the example in which the closed slits 2122 are arranged in the center land 212 has been shown in the aforementioned second embodiment, the present invention is not limited to this. In the present invention, the bent slits and the closed slits may not be arranged in the center land.

While the example in which the raised bottom portions 125 (3125) are arranged in the bent slits 122 (3122) of each of the center lands 12 (312) has been shown in the aforementioned first and third embodiments, the present invention is not limited to this. In the present invention, the raised bottom portions may not be arranged in the bent slits.

While the example in which the shoulder slits 111 (211, 311) are arranged in each of the shoulder lands 11 (2111, 3111), and the shoulder land 11 (211, 311) is divided in the tire circumferential direction by the shoulder slits has been shown in the aforementioned first to third embodiments, the present invention is not limited to this. In the present invention, the shoulder slits may not be arranged in the shoulder land.

While the example in which the shoulder slits 111 (2111, 3111) arranged in the each of the shoulder lands 11 (211, 311) have the same inclination angle as each other with respect to the tire axial direction has been shown in the aforementioned first to third embodiments, the present invention is not limited to this. In the present invention, the shoulder slits arranged in the shoulder land may have different inclination angles from each other with respect to the tire axial direction.

While the example in which the raised bottom portions 113 (2113, 3113) are arranged in the shoulder slits 111 (2111, 3111) of each of the shoulder lands 11 (211, 311) has been shown in the aforementioned first to third embodiments, the present invention is not limited to this. In the present invention, the raised bottom portions may not be arranged in the shoulder slits.

While the example in which the center sipes 123 (2123, 3123) are arranged in each of the center lands 12 (212, 312) has been shown in the aforementioned first to third embodiments, the present invention is not limited to this. In the present invention, the center sipes may not be arranged in the center land.

While the example in which the shoulder sipes 112 (2112, 3112) are arranged in each of the shoulder lands 11 (211, 311) has been shown in the aforementioned first to third embodiments, the present invention is not limited to this. In the present invention, the shoulder sipes may not be arranged in the shoulder land.

While the example in which both the first circumferential grooves 313 and the second circumferential groove 314 are formed to extend in serrated zigzag shapes in the tire circumferential direction, and have internal angles between their line segments that are not greater than 90 degrees has been shown in the aforementioned third embodiment, the present invention is not limited to this. In the present invention, at least one of the first circumferential grooves or the second circumferential groove may be formed to extend in a serrated zigzag shape in the tire circumferential direction, and has an internal angle between line segments of the groove that is not greater than 90 degrees.

1. A tire comprising a tread, wherein
the tread includes
a pair of shoulder lands arranged on outer sides in a tire axial direction,
a center land or center lands arranged between the pair of shoulder lands,
first circumferential grooves each of which is arranged either between a respective one of the shoulder lands and the center land or between a respective one of the shoulder lands and one of the center lands that is positioned closer to the shoulder land and formed to extend in a zigzag shape in a tire circumferential direction, and
a second circumferential groove arranged in the center land or between the center lands and formed to extend in a zigzag shape in the tire circumferential direction; and
an amplitude of the zigzag shape of the second circumferential groove is equal to or smaller than an amplitude of the zigzag shape of each of the first circumferential grooves.

2. The tire according to claim 1, wherein a groove width of the second circumferential groove is smaller than a groove width of each of the first circumferential grooves.

3. The tire according to claim 1, wherein the amplitude of the zigzag shape of the second circumferential groove is not greater than 3% of a width of the tread.

4. The tire according to claim 1, wherein
the center land or each of the center lands includes
center slits formed to be inclined with respect to the tire axial direction and connecting one of the first circumferential grooves to the second circumferential groove to divide the center land, and
closed slits formed to extend from one of the first circumferential grooves and from the second circumferential groove and to be inclined with respect to the tire axial direction and terminating in the center land, or bent slits formed by line segments extending from one of the first circumferential grooves and the second circumferential groove to be inclined with respect to the tire axial direction and joined together to form a bent shape in the center land; and
an inclination angle of each of the center slits is equal to an inclination angle of each of the closed slits or each of the bent slits.

5. The tire according to claim 4, wherein
each of the shoulder lands includes shoulder slits extending from a respective one of the first circumferential grooves outward in the tire axial direction to be inclined and to divide the shoulder lands; and
inclination angles of the shoulder slits with respect to the tire axial direction are equal to each other.

6. The tire according to claim 4, wherein the center land further includes center sipes formed to extend at an inclination angle identical to each of the center slits.

7. The tire according to claim 5, wherein each of the shoulder lands further includes shoulder sipes connected to the first circumferential groove and formed to extend at an inclination angle identical to each of the shoulder slits.

8. The tire according to claim 5, wherein an inclination direction of each of the center slits with respect to the tire axial direction is equal to an inclination direction of each of the shoulder slits; and
the center slits and the shoulder slits are formed such that a center line of each of the center slits intersects a center line of a corresponding one of the shoulder slits at a point within the shoulder slit.

9. The tire according to claim 8, wherein the inclination angle of each of the center slits with respect to the tire axial direction is greater than the inclination angle of each of the shoulder slits with respect to the tire axial direction.

10. The tire according to claim 5, wherein
an inclination direction of each of the center slits with respect to the tire axial direction is equal to an inclination direction of each of the shoulder slits; and
the center slits and the shoulder slits are formed such that a center line of each of the center slits is colinear with a center line of a corresponding one of the shoulder slits.

11. The tire according to claim 4, wherein the center land further includes raised bottom portions arranged in the bent slits and having a depth from not smaller than 35% to not greater than 55% of a depth of the second circumferential groove.

12. The tire according to claim 4, wherein the center land or each of the center lands includes lands separated by the center slits, and raised bottom portions arranged in the center slits to connect the lands to each other and having a depth from not smaller than 35% to not greater than 55% of a depth of the second circumferential groove.

13. The tire according to claim 4, wherein the inclination angle of each of center slits is not smaller than 15 to not greater than 25 degrees with respect to the tire axial direction.

14. The tire according to claim 4, wherein each of the bent slits includes a first portion connected to a corresponding one of the first circumferential groove as one of the line segments, a second portion connected to the second circumferential groove as another of the line segments, and a third portion connecting the first portion to the second portion; an inclination angle of the first portion with respect to the tire axial direction is equal to an inclination angle of the second portion; and a groove width of the third portion is smaller than a groove width of each of the first and second portions.

15. The tire according to claim 1, wherein the tread includes three grooves as the first circumferential grooves and the second circumferential groove formed to extend in the tire circumferential direction, and four lands separated as the shoulder lands and the center lands by the three grooves.

16. The tire according to claim 1, wherein at least one of the first circumferential grooves or the second circumferential groove is formed to extend in a serrated zigzag shape in the tire circumferential direction, and has an internal angle between line segments of the groove that is not greater than 90 degrees.
